(19) United States
(12) Patent Application Publication
(10) Pub. No.: US 2025/0047935 A1
(43) Pub. Date: Feb. 6, 2025

(54) Congestion Aware Hybrid File Transfer

(71) Applicant: Edge Networks, Inc., Sun Valley, ID (US)

(72) Inventor: Todd Achilles, Sun Valley, ID (US)

(73) Assignee: Edge Networks, Inc., Sun Valley, ID (US)

(21) Appl. No.: 18/741,729

(22) Filed: Jun. 12, 2024

Related U.S. Application Data
(63) Continuation of application No. 16/578,159, filed on Sep. 20, 2019, now abandoned.
(60) Provisional application No. 62/831,136, filed on Apr. 8, 2019.

(51) Int. Cl. H04N 21/442; G01S 5/02; H04B 17/318; H04N 7/01; H04N 21/233; H04N 21/234; H04N 21/2381; H04N 21/258; H04N 21/433; H04N 21/439; H04N 21/4402; H04N 21/45; H04N 21/466; H04N 21/482; H04N 21/61; H04N 21/6405; H04N 21/6408; H04W 4/029; H04W 64/00

(52) U.S. Cl. CPC H04N 21/44222; G01S 5/0252; H04B 17/318; H04N 7/0117; H04N 7/013; H04N 21/233; H04N 21/234; H04N 21/2381; H04N 21/25891; H04N 21/4331; H04N 21/4398; H04N 21/4402; H04N 21/44204; H04N 21/4532; H04N 21/4662; H04N 21/482; H04N 21/6125; H04N 21/6405; H04N 21/6408; H04W 4/029; H04W 64/003

(57) ABSTRACT

A method of delivering audiovisual content to a viewer includes monitoring a viewer activity, prompting viewer to determine intent upon the occurrence of a pre-specified event, identifying content for delivery based on a response from the viewer and selectively delivering the content to the viewer, wherein the delivery is via a broadband connection during a non-peak data traffic time.

### RELATED APPLICATIONS/CLAIM FOR PRIORITY

This application claims the benefit of the filing date of U.S. Provisional Application No. 62/831,136 filed on Apr. 8, 2019. The subject matter of the provisional application is incorporated herein in its entirety by reference.

### BACKGROUND

This disclosure is directed to television transmission and more specifically to transmission over different media to a viewer.

A recently adapted television standard, ATSC 3.0 (Advanced Television Systems Committee), provides for a hybrid delivery of television signals. The signals can be delivered over different media. In addition to over the air (OTA) broadcast (first medium), this standard provides for transmission over a broadband connection (second medium) to a viewer.

OTA interface is a traditional media for broadcasting to all receivers within a physical viewing range. Transmission over a broadband (or network), on the other hand, can take place via unicast (one destination) or multicast (multiple destinations).

Traditional consumer ISPs (Internet service providers), utilizing unicast data networks, are overwhelmed by video streaming traffic. During the peak hours (typically between 5 to 10 PM), video streaming can consume as much as 90% of bandwidth. During non-peak periods, bandwidth is abundant and the marginal cost is effectively zero because ISPs pay by bandwidth rather than aggregate packets sent/received.

What is desired, therefore, is a system and a method that leverage the functionality of ATSC 3.0 to provide viewers with options.

### SUMMARY

According to an exemplary embodiment, a method for delivering audiovisual content to a viewer is disclosed. The method comprises: monitoring a viewer activity; prompting viewer to determine intent upon the occurrence of a pre-specified event; identifying content for delivery based on a response from the viewer; and selectively delivering the content to the viewer, wherein the delivery is via a broadband connection during a non-peak time.

According another exemplary embodiment, a method of delivering audiovisual content to a viewer is disclosed. The method comprises: monitoring a viewer activity; training a machine to learn viewer tendencies based on the monitored activity; identifying content for delivery based on the learned viewer tendencies; and selectively delivering the content to the viewer, wherein the delivery is via a broadband connection during a non-peak time.

According to a further exemplary embodiment, a system for delivering audiovisual content to a viewer is disclosed. The system comprises: a media source containing audiovisual content; a receiver located within a viewer premises; a communication network connecting the media source to the settop box; and a system controller for facilitating delivery of audio visual content to the receiver, wherein the communication network provides content to the receiver during a non-peak time.

According to yet another exemplary embodiments, an interactive system for providing audiovisual content to a viewer is disclosed. The system comprises: a media source containing audiovisual content; a transmitter for broadcasting audiovisual signals corresponding to the content over the air (OTA) on a primary channel from the media source; a communication network connecting the media source to a viewer premises for transmitting the audiovisual signals; a receiver located within the viewer premises for receiving the broadcast and network signals; and a system controller. The system controller determines viewer intent based on the OTA signals being viewed; identifies audiovisual content for transmission based on the viewer intent; and broadcasts the identified audiovisual content to the receiver in real time on at least one secondary channel, wherein the content broadcast on the secondary channel is stored in memory of the receiver.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a method in accordance with exemplary embodiments;

FIG. 2 illustrates another method in accordance with exemplary embodiments;

FIG. 3 illustrates a further method in accordance with exemplary embodiments; and

FIG. 4 illustrates a system in accordance with exemplary embodiments;

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the exemplary embodiments.

Reference throughout this specification to an “exemplary embodiment” or “exemplary embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

In order to overcome the inefficiency highlighted above, exemplary embodiments utilize efficient multicast transmission in conjunction with local storage. The multicast transmission and local storage may be combined with an insight or understanding of the viewer's preferences to download content during non-peak periods. Such downloaded content can be played back locally during peak viewing periods.

In an exemplary scenario, a viewer may be watching the fourth episode of season 1 of ‘Program X’. The set-top box (STB) can determine her or his viewing intent and download the remaining episodes of Program X for season 1 from a network content server.

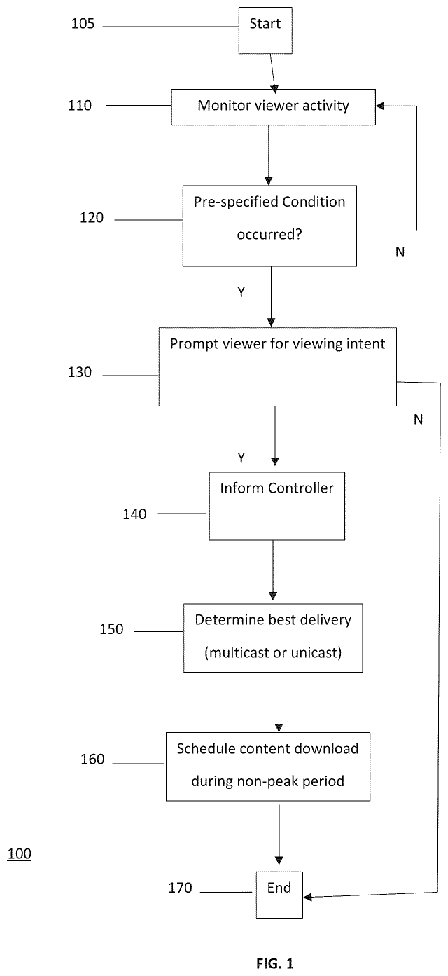

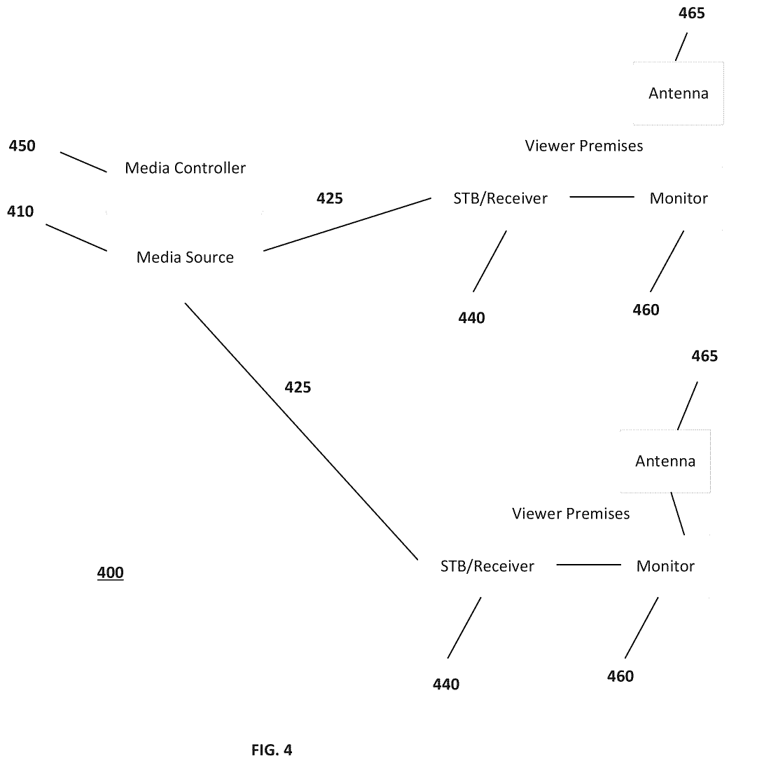

The viewing intent (of a viewer) can be determined in accordance with a plurality of exemplary implementations. A system for executing the method or process steps described with reference to FIGS. 1 to 3 below is described in detail further below with reference to FIG. 4.

In an exemplary implementation as illustrated in FIG. 1, an interactive approach/process 100 may be utilized. A viewer's activity (viewer activity) may be monitored at 110. The occurrence of a pre-specified event may be monitored as part of this process at 120.

An exemplary pre-specified event may be the number of episodes of a particular program that has been viewed by the viewer for example. If the event has not occurred, the viewer activity may (continue to be) monitored at 110. If the condition has occurred, viewer intent may be determined by prompting the viewer for a response at 130. In the example cited above, after a pre-specified number of episodes from season 1 of Program X have been viewed, an on-screen pop-up may ask the viewer if he or she wishes to view additional episodes from season 1 for example.

If the viewer response necessitates informing a program (or video) controller of next steps, such communication to the controller may take place at 140. In the example cited above, a logic engine in the set-top-box (STB) may communicate to a network content server or media source (via the controller) that remaining episodes of Program X need to be downloaded for local storage. The network content server or controller may determine if the most efficient file delivery is over the multicast network or downloading over a unicast ISP connection at 150.

A unicast download may take place if only one viewer intents or desires to watch a particular program. A multicast download may take place if the viewing habits or intentions of multiple viewers indicates that a particular program (and number of episodes) needs to be downloaded to multiple viewers.

If the viewer response (at 130) indicates that no additional steps are necessary (a user responds that he or she does not wish to view additional episodes for example), then additional action may not be necessary and the process continues to 170.

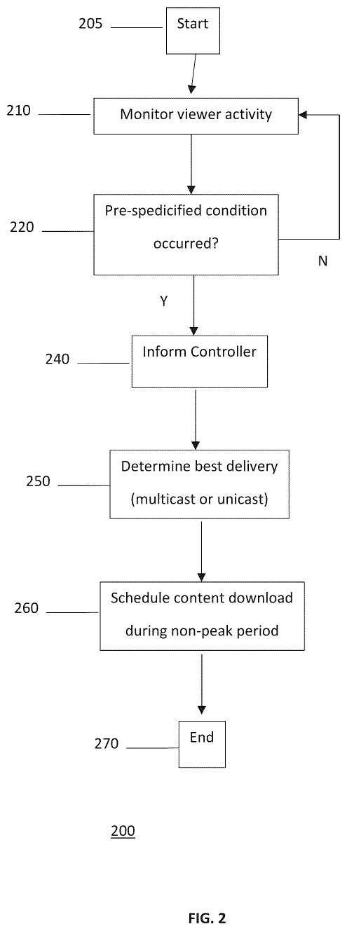

In another exemplary implementation, an automated approach/process 200 may be utilized as illustrated in FIG. 2. Process 200 is similar to process 100 (steps 105, 110, 120, 140, 150, 160 and 170 of FIG. 1 corresponds to steps 205, 210, 220, 240, 250, 260 and 270 of FIG. 2). The exception is that a viewer is not being prompted to indicate viewer intent (corresponding to step 130). The occurrence of a pre-specified event at 220 may determine the remaining steps as highlighted in process steps 240 to 270.

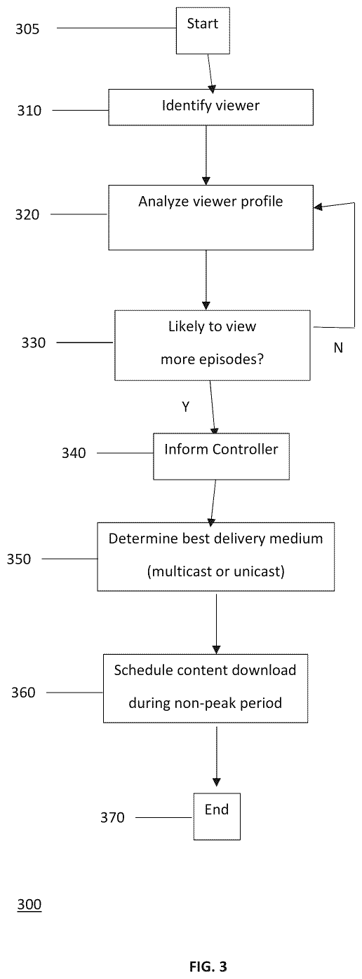

In a further exemplary implementation, a machine learning process 300 may be utilized as illustrated in FIG. 3. A viewer may be indented at 310. The identified viewer's profile may be analyzed at 320. The profile of the viewer may have been built or developed over a period of time based on viewer's previous viewing habits. The profile may have been built using learning techniques incorporating artificial intelligence.

Upon analyzing the viewing habits, the type of programming that is likely to be viewed may be identified at 330. One type of programming that is identified may be more episodes of a program that is being viewed for example. Another type of programming that is identified may be a similar types of program(s). The identified programming may be communicated to the controller at 340.

The controller may determine if the most efficient file delivery is over the multicast network or downloading over a unicast ISP connection at 350 as described above. The identified content using the determined form of delivery is delivered at 360.

In this implementation, an error may also be calculated by comparing the actual number of downloaded episodes viewed with the total number of downloaded episodes. The machine learning may adjust the estimate based on the calculated error.

As with the interactive and automated approaches described above, the STB may communicate to the network that the remaining episodes (of season 1 for example) should be downloaded and the downloaded episodes will be stored locally. A determination may be made by the network content server or controller as to whether file delivery is over a multicast network or over a unicast ISP connection.

If the viewer is a first time viewer or one without a pre-determined amount of viewing activity, process 100 or 200 may be more appropriate.

Unlike the interactive and automated implementations described above, the machine learning implementation may be more dynamic and evolving.

A system in accordance with exemplary embodiments is illustrated in FIG. 4. System 400 may include a media source 410. Media source may include programming in the form of audio-visual content/data. Media content can include non-live programming data such as multiple episodes of a television program for example stored in memory associated with the media source. Media source can provide “live” programming as well.

System 400 may also include a receiver 440 located within a viewer premises. A viewing device, such as a monitor 460, may be connected to the receiver 440. Receiver 440 can be integrated within a set-top-box (STB).

Media source may broadcast programming (i.e. audio-visual content/data) over the air (OTA) using known techniques (not specifically illustrated). The broadcast programming may be received by an antenna 465 connected to the monitor. Antenna 465 may facilitate reception of broadcast signals for display on monitor 460 utilizing known methods.

Media source 410 can be connected to receiver 440 via a network 425 such as the internet. A cable modem can be used. In some embodiments, the network connection between the media source and the receiver can be a fixed wireless network. The network can be implemented utilizing WISP or 5G technology or the like.

The data from the media source can be communicated to a receiver via an IP-based unicast connection. Data from the media source can be communicated to multiple receivers via a multicast connection provided for by ATSC 3.0 standard. Unicast or multicast transmission may take place over network 425. While a separate network (425) is illustrated for each of the viewer premises, a common network path can exist for at least a portion of the distance from the controller to the multiple viewer premises. The path can then split up to individual viewer premises.

System 400 also includes a controller 450 for providing the co-ordination and orchestration of the various components of system 400. Controller 450 is illustrated as being co-located with media source 410 but need not be so arranged.

A viewer may interact with the STB via a remote control to indicate her or his preferences. Controller 450 may be a general purpose computer having a processor, a memory, a communication interface, a bus, etc. Controller may be programmed or configured to communicate with a STB/receiver of a viewer premises. Controller can also control the media source.

In order to illustrate a potential multicasting scenario, multiple viewer premises (two in this case) are included in FIG. 4.

In another exemplary embodiment, an interactive system for providing audiovisual content to a viewer is disclosed. The system can include a media source, a transmitter, a communication network, a receiver and a system controller. The media source can contain audiovisual content, The transmitter can broadcasting audiovisual signals corresponding to the content over the air (OTA) on a primary channel from the media source. The communication network can connect the media source to a viewer premises for transmitting the audiovisual signals. The receiver can be located within the viewer premises for receiving the broadcast and network signals. The system controller can determine viewer intent based on the OTA signals being viewed, identify audiovisual content for transmission based on the viewer intent and broadcast the identified audiovisual content to the receiver in real time on at least one secondary channel. The content broadcast on the secondary channel can be stored in a memory of the receiver.

Primary and secondary (or sub) channels can be associated with a particular frequency in a digital broadcast system.

In some embodiments, related programming can be transmitted to a user premises using digital subchannels (i.e. OTA).

The hybrid multicast/unicast file transfer combined with local storage and time shift between downloading and viewing of video as described above overcomes the video streaming congestion experienced during peak hours. The reach and efficiency of UDP multicast (from ATSC 3.0) is combined with the precision and reliability of TCP unicast. ATSC 3.0 is designed to maximize throughput in a closed loop system.

Although exemplary embodiments have been disclosed, it will be apparent to those skilled in the art that various changes and modifications can be made which will achieve some of the advantages of embodiments without departing from the spirit and scope of the disclosure. Such modifications are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1-14. (canceled)

15. A method of delivering audiovisual content to a viewer, the method comprising:
monitoring a viewer activity including monitoring the content received by the user, the content being broadcast on a primary channel via an over the air (OTA) interface;
determining if a pre-specified condition has occurred while monitoring the viewer activity;
prompting the viewer to indicate an intent following a determination that the pre-specified event has occurred;
identifying, by a set top box associated with the viewer, content for delivery based on the indication from the viewer; and
delivering the identified content to the viewer over the air on a secondary channel associated with the primary channel in a digital broadcast system wherein the primary and the secondary channel are associated with a particular frequency.

16. The method of claim 15, further comprising:
identifying content for delivery to a plurality of viewers based on responses received from the plurality of viewers;
delivering the identified content via a broadband connection during a non-peak time.

17. The method of claim 16, further comprising:
delivering the identified content to at least two viewers via a multicast delivery if identical content has been designated for delivery to at least two viewers.

18. The method of claim 16, further comprising:
delivering the identified content to a viewer via unicast delivery if identical content has not been designated for delivery to multiple viewers.

19. The method of claim 16, wherein the content delivered over the air on the secondary channel is archived in a storage medium associated with the viewer.

20. The method of claim 16, wherein the signals delivered over the secondary channel are viewed in real-time.

21. The method of claim 15, wherein the occurrence of a pre-specified event comprises:
determining if a number of episodes of a particular program viewed is greater than a pre-set number.

22. The method of claim 15, further comprising:
continue monitoring of viewer activity following a determination that the pre-specified condition has not occurred.

23. A system for delivering audiovisual content to a viewer, the system comprising:
a receiver located within a viewer premises for receiving the audiovisual content;
a communication network connecting the receiver to a media source; and
a system controller for facilitating delivery of the audiovisual content to the receiver, wherein the receiver receives audiovisual signals corresponding to the content over the air (OTA) and over the communication network, wherein the system controller is configured to:
monitor a viewer activity including monitoring the content received by the viewer, the content being broadcast on a primary channel via an over the air (OTA) interface;
determine if a pre-specified condition has occurred while monitoring the viewer activity;
prompt the viewer to indicate an intent following a determination that the pre-specified event has occurred;
identify audiovisual content for transmission based on the indication from the viewer; and
broadcast the identified content over a secondary channel associated with the primary channel wherein the primary and the secondary channel are associated with a particular frequency.

24. The system of claim 23, wherein the delivery over the network is via a unicast stream to the receiver.

25. The system of claim 23, wherein the delivery over the network is via a multicast stream to a plurality of receivers.

26. The system of claim 23, wherein the audiovisual content includes at least one of images, streaming video, text and sound.

27. The system of claim 23, wherein viewer interaction with the system controller is via the network.

28. The system of claim 23, wherein the network is the internet.

29. The system of claim 23, wherein the network is a wireless network.

30. The system of claim 23, wherein the received signals are stored in a memory.

31. The system of claim 23, wherein the system controller is further configured to:
continue monitoring of viewer activity following a determination that the pre-specified condition has not occurred.
